(19) United States
(12) Patent Application Publication
(10) Pub. No.: US 2024/0376672 A1
(43) Pub. Date: Nov. 14, 2024

(54) METHOD FOR MANUFACTURING PAPER AND CARDBOARD

(71) Applicant: SNF GROUP, ANDREZIEUX BOUTHEON (FR)

(72) Inventors: Cyril BARRIERE, ANDREZIEUX BOUTHEON (FR); Gatien FAUCHER, ANDREZIEUX BOUTHEON (FR); Bastien MARTEL, ANDREZIEUX BOUTHEON (FR)

(21) Appl. No.: 18/286,529

(22) PCT Filed: Apr. 13, 2022
(86) PCT No.: PCT/EP2022/059953

§ 371 Date: Oct. 11, 2023

(30) Foreign Application Priority Data
Apr. 15, 2021 (FR) 2103910

(51) Int. Cl. D21H 21/10; C08F 8/06; C08F 8/28; D21H 17/37; D21H 21/18; D21H 23/04

(52) U.S. Cl. CPC D21H 21/10; C08F 8/06; C08F 8/28; D21H 17/375; D21H 21/18; D21H 23/04

(57) ABSTRACT

A method for producing a sheet of paper or cardboard from a fibrous suspension, includes injection of a polymer P2 into a fibrous suspension, forming of a sheet of paper or cardboard, and drying the sheet of paper or cardboard. The polymer P2 is prepared, before injection of the polymer P2, from a water-soluble polymer P1 in the form of solid particles. Polymer P1 consists of at least one nonionic monomer selected from acrylamide, methacrylamide, N,N-dimethylacrylamide, and acrylonitrile. Polymer P1 is subjected to a reaction Re to yield polymer P2. The reaction Re includes the addition and the dissolution of solid particles of polymer P1 in an aqueous solution M1 of an alkali hydroxide and/or an alkaline earth hydroxide, and an alkali hypohalide and/or an alkaline earth hypohalide, prior to a reaction time of 10 seconds to 5 hours.

### FIELD OF THE INVENTION

The present invention relates to a method for producing paper or cardboard having improved drainage and machinability properties. More precisely, the invention relates to a method involving the reaction of a water-soluble polymer in the form of solid particles in a mixture of hydroxide (alkali metal hydroxide and/or alkaline earth metal hydroxide) and of hypohalide (alkali metal hypohalide and/or alkaline earth metal hypohalide) to be injected later directly into the fibrous suspension used to produce the paper or the cardboard.

The present invention also relates to paper and cardboard having the improved physical properties obtained by this method.

### PRIOR ART

The paper industry is constantly seeking to optimize its paper or cardboard production methods, more particularly in terms of yield, productivity, cost reduction, and quality of the finished products.

The use of polymers as agents for dry strength, drainage and machinability has been described very extensively.

The drainage properties relate to the capacity of the fibrous mat to remove or drain the maximum amount of water before the dryer section. Improved drainage properties involve energy savings and an increase of the production capacity.

Machinability designates the optimization of the operation of the paper-making machine by increasing the productivity due to better drainage on the table, better dryness in the press section, less breakage due to greater cleanliness of the circuits and less deposition.

WO 2006/075115 describes a method for producing a sheet of paper or cardboard using at least two dry strength agents, respectively:
a first agent obtained by the Hofmann degradation reaction on a (co)polymer base, and
a second agent corresponding to a (co)polymer having an anionic charge density greater than 0.1 meq/g.

U.S. Pat. No. 4,110,520 describes the modification of a polymer in solid form. This polymer is not dissolved during its modification.

EP 2 536 489 describes a device for dispersing and grinding a polymer.

EP 2 840 100 describes the functionalization of a polymer by means of a polyfunctional compound.

U.S. Pat. No. 5,292,821 describes a method for producing paper involving a cationic polyacrylamide.

Polyvinylamines are known to improve drainage during the forming of the paper.

Polyvinylamines can be obtained by reacting a solution of polyacrylamide in a mixture of alkali hydroxide and/or of alkaline earth hydroxide and of alkali hypohalide and/or of alkaline earth hypohalide followed by treatment in an acidic medium.

When the reaction is carried out directly before injection of the product into the fibrous suspension for obtaining the paper or the cardboard, only the reaction of the polyacrylamide in solution with the alkali or alkaline earth hydroxides and hypohalides is carried out.

However, this necessity of having polyacrylamide solutions implies their transport to the paper mill or the necessity of having equipment for dissolving the polymer in particle form in the paper mill. In both cases, the footprint of the stocks of polymer solutions or of the dissolution equipment remains large.

In addition, this reaction on the polyacrylamide requires heating the reaction medium and also requires an exchanger in order to regulate its temperature at the end of the reaction.

### DESCRIPTION OF THE INVENTION

Unexpectedly, the Applicant discovered that a method involving the reaction of a water-soluble polymer in the form of solid particles in a mixture of hydroxide (alkali metal hydroxide and/or alkaline earth metal hydroxide) and of hypohalide (alkali metal hypohalide and/or alkaline earth metal hypohalide) and to be then injected directly into the fibrous suspension used to produce the paper or the cardboard makes it possible to improve the drainage and dry strength properties.

This method also makes it possible to avoid a whole logistics scheme (transport or installation of a dissolution unit) inherent in the handling of solutions of water-soluble polymers.

In addition, the method becomes simpler when the dissolution of the polymer in the reaction mixture of alkali and/or alkaline earth hydroxide and hypohalide occurs very rapidly and when it is not necessary to heat the reaction medium or to use heat exchangers.

“Alkali” designates an alkali metal, advantageously lithium, sodium or potassium. An “alkali hydroxide” designates a hydroxide (OH⁻) of at least one alkali metal, for example, NaOH, KOH or NaOH+KOH. The same applies for the alkaline earth hydroxide.

“Alkaline earth” designates an alkaline earth metal, advantageously calcium or magnesium.

A hypohalide is an oxyanion, for example, hypochlorite ClO⁻.

An “alkali hypohalide” designates a hypohalide of at least one alkali metal and at least one hypohalide, for example, NaOCl, KOBr or NaOCl+KOBr. The same applies for the alkaline earth hypohalide.

Finally, since the range of molecular weights of the water-soluble polymers in the form of solid particles is large, the method of the invention makes it possible to increase the current range of drainage and dry strength agents compared to a similar method using polyacrylamides in the form of an aqueous solution.

More precisely, the invention relates to a method for producing a sheet of paper or cardboard from a fibrous suspension, comprising the following steps:
a) injection of a polymer P2 into a fibrous suspension (advantageously an aqueous suspension of cellulosic fibers),
b) forming of a sheet of paper or cardboard,
c) drying of the sheet of paper or cardboard,
the polymer P2 being prepared, before step a), from a water-soluble polymer P1 in the form of solid particles, P1 being a water-soluble polymer of at least one nonionic monomer selected from acrylamide, methacrylamide, N,N-dimethylacrylamide, and acrylonitrile,
the polymer P2 being obtained by a reaction Re comprising (advantageously consisting of) the addition and the dissolution of the solid particles of water-soluble polymer P1 in an aqueous solution M1 comprising: (i) an alkali metal hydroxide, or an alkaline earth metal hydroxide or mixtures thereof, (ii) an alkali metal hypohalide, or an alkaline earth metal hypohalide or mixtures thereof,
the reaction Re having a reaction time of 10 seconds to 5 hours after the addition of the particles of water-soluble polymer P1.

The water-soluble polymer P1 is thus dissolved in the aqueous solution M1 during the reaction Re.

Advantageously, step a) is carried out within a time period not exceeding 24 hours counting from the start of the reaction Re, that is to say counting from the addition of the solid particles of water-soluble polymer P1 to the aqueous solution M1.

In the continuation of the description and in the claims, all the polymer dosages expressed in g·t⁻¹ or kg·t⁻¹ are given in weight of polymer per tonne of dry matter. The dry matter corresponds to the dry extract obtained after evaporation of the water from the fibrous suspension used in a method for producing a sheet of paper or cardboard. The dry matter advantageously consists of cellulosic fibers and fillers. The term “cellulosic fibers” encompasses any cellulose entity comprising fibers, fines, microfibrils or nanofibrils. Fibrous suspension is understood to mean the thick pulp or the diluted pulp based on water and cellulosic fibers. The thick pulp (Thick Stock) having a dry matter mass concentration generally greater than 1%, or even greater than 3%, is upstream of the mixing pump (fan-pump). The diluted pulp (Thin Stock) having a dry matter mass concentration generally less than 1% is located downstream of the mixing pump.

The term “polymer” designates homopolymers as well as copolymers of at least two different monomers.

An amphoteric polymer is a polymer comprising cationic charges and anionic charges, preferably as many anionic charges as cationic charges.

As used here, the term “water-soluble polymer” designates a polymer which yields an aqueous solution with no insoluble particles when it is dissolved under stirring for 4 hours at 25° C. and at a concentration of 20 g·L⁻¹ in deionized water.

The ranges of values include the lower and upper limits. Thus, the ranges of values “between 0.1 and 1.0” and “from 0.1 to 1” include the values 0.1 and 1.0.

The water-soluble polymer P1 is a polymer of at least one nonionic monomer selected from acrylamide, methacrylamide, N,N-dimethylacrylamide, and acrylonitrile. Preferably, the polymer P1 contains at least 50 mol % of at least one of these nonionic monomers.

The polymer P1 can also contain anionic and/or cationic and/or zwitterionic monomers. The polymer P1 advantageously is free of nonionic monomer not selected from acrylamide, methacrylamide, N,N-dimethylacrylamide, and acrylonitrile.

The anionic monomers are preferably selected from the group comprising the monomers having a carboxylic acid function and salts thereof, including acrylic acid, methacrylic acid, itaconic acid, maleic acid, the monomers having a sulfonic acid function and salts thereof, including acrylamide tertiary-butyl sulfonic acid (ATBS), allyl sulfonic acid, and methallyl sulfonic acid and salts thereof; and the monomers having a phosphonic acid function and salts thereof.

In general, the salts of anionic monomers of the polymer P1 are salts of an alkali metal, of an alkaline earth metal or of an ammonium (preferably a quaternary ammonium).

The cationic monomers are preferably selected from the group comprising quaternized or salified dimethylaminoethyl acrylate (ADAME), quaternized or salified dimethylaminoethyl methacrylate (MADAME), diallyldimethylammonium chloride (DADMAC), acrylamidopropyltrimethylammonium chloride (APTAC), and methacrylamidopropyltrimethylammonium chloride (MAPTAC).

Advantageously, the cationic monomers of the polymer P1 have as counterion a halide, preferably a chloride ion.

The zwitterionic monomers are preferably selected from the group comprising the sulfobetaine monomers such as sulfopropyl dimethylammonium ethylmethacrylate, sulfopropyl dimethylammonium propylmethacrylamide, or sulfopropyl-2-vinylpyridinium; the phosphobetaine monomers such as phosphate ethyltrimethylammonium ethylmethacrylate; and the carboxybetaine monomers.

Preferably, the water-soluble polymer P1 is a homopolymer or a copolymer of acrylamide or of methacrylamide.

The polymer P1 can be linear, structured or cross-linked. The cross-linking agents enabling the structuring can notably be selected from sodium allyl sulfonate, sodium methallyl sulfonate, sodium methallyl disulfonate, methylenebisacrylamide, triallylamine, triallylammonium chloride.

The structuring of the polymer P1 can also be obtained with at least one polyfunctional compound containing at least 3 heteroatoms selected from N, S, O, P and each having at least one mobile hydrogen. This polyfunctional compound can notably be a polyethyleneimine or a polyamine.

The reaction Re comprises the addition and the dissolution of the solid particles of polymer P1 in an aqueous solution M1 of: (i) an alkali hydroxide and/or an alkaline earth hydroxide, (ii) an alkali hypohalide and/or an alkaline earth hypohalide, with a time of reaction Re of 10 seconds to 5 hours in order to form the polymer P2.

Advantageously, the aqueous solution M1 is an aqueous solution of soda (sodium hydroxide) and sodium hypochlorite.

Advantageously, the reaction time of the polymer P1 in the aqueous solution M1 of hypohalide and hydroxide is 10 seconds to 180 minutes.

The reaction Re is advantageously carried out at a temperature between 10 and 30° C., more advantageously between 15 and 25° C.

Preferably, for the reaction Re, the coefficient Alpha=moles of (alkali and/or alkaline earth) hypohalide/moles of monomer(s) nonionic (acrylamide, methacrylamide, N,N-dimethylacrylamide, acrylonitrile or mixtures thereof) of the polymer P1 is between 0.1 and 1.0, and the coefficient Beta=moles of (alkali and/or alkaline earth) hydroxide/moles of (alkali and/or alkaline earth) hypohalide is between 0.5 and 4.0.

The reaction Re is advantageously carried out by the addition of polymer P1 in the form of solid particles to the aqueous solution M1. Preferably, the solid particles of polymer P1 are in the form of powder, microbeads, solid particles in an oily suspension, or solid particles in an aqueous suspension.

These different forms of solid particles are obtained by techniques known to a person skilled in the art.

The powder form of the polymer P1 can be obtained by gel polymerization, precipitation polymerization or spray drying of the inverse emulsion polymer.

The microbeads of polymer P1 are advantageously obtained by inverse suspension polymerization.

The oily suspensions of solid particles of polymer P1 can be obtained by distillation of the inverse emulsion polymer or by suspension of the polymer in an oil. The oily suspensions can contain between 10 and 60% by weight of particles of polymer P1.

The aqueous suspensions of solid particles of polymer P1 are advantageously obtained by dispersion polymerization (in a brine) or by suspension of the polymer in a brine. The aqueous suspension can contain between 10 and 50% by weight of particles of polymer P1.

Even more preferably, the polymer P1 is added to the reaction medium in the form of a powder resulting from gel polymerization or of microbeads resulting from inverse suspension polymerization.

When the polymer P1 is in powder form, it is preferably dispersed and solubilized in an aqueous solution M1 by means of a device for dispersing and grinding the polymer, notably a PSU (Polymer Slicing Unit, document WO2011107683), supplied by a circuit of the aqueous solution M1. A person skilled in the art knows how to adapt the production equipment of this type of device so that it resists the aqueous solution M1 of hydroxide and hypohalide.

For the reaction Re, preferably between 0.1 and 20% by weight of solid particles of polymer P1 with respect to the weight of the aqueous solution M1, more preferably between 0.3 and 10%, and even more preferably between 0.5 and 3.0 by weight, are added to the aqueous solution M1.

Advantageously, at the end of the reaction Re and before its injection into the fibrous suspension, the polymer P2 can be functionalized with a compound comprising at least one aldehyde function in order to yield a polymer P3, for example by addition of a compound comprising at least one aldehyde function. Preferably, the compound comprising at least one aldehyde function is glyoxal.

Preferably, before injection into the fibrous suspension, the pH of the reaction mixture obtained by the reaction Re and containing the polymer P2 can be adjusted by addition of acid between 0.5 and 7.5, more preferably between 1.0 and 3.0. A person skilled in the art knows how to adjust the pH of this type of reaction medium. The adjustment of the pH is advantageously carried out in the absence of forming of the polymer P3.

According to a preferred embodiment, the polymer P2 (or P3) is introduced into the white water and/or the thick pulp and/or the mixture formed by the white water and the thick pulp after homogenization of the fibrous suspension in the dilution pump (fan pump).

Advantageously, the polymer P2 (or P3) can also be introduced within the paper-making process at the forming table, for example, by spraying or in the form of a foam, or at the size press (coating machine).

Advantageously, between 0.1 and 10 kg·t⁻¹ and preferably between 0.2 and 5.0 kg·t⁻¹ of polymer P2 (or P3) are added to the fibrous suspension.

The fibrous suspension encompasses the possible use of different cellulosic fibers: virgin fibers, recycled fibers, chemical pulp, mechanical pulp, microfibrillated cellulose or nanofibrillated cellulose. The fibrous suspension also encompasses the use of these different cellulosic fibers with all types of fillers such as TiO₂, CaCO₃ (crushed or precipitated), kaolin, organic fillers and mixtures thereof.

The polymer P2 or P3 can be used within the paper-making process in combination with other products such as mineral or organic coagulants, dry strength agents, wet strength agents, natural polymers such as starches or carboxymethylcellulose (CMC), inorganic microparticles such as bentonite microparticles and colloidal silica microparticles, organic polymers of any ionic type (nonionic, cationic, anionic, or amphoteric) and which can be (without being limited to) linear, branched, crosslinked, hydrophobic or associative polymers.

The following examples illustrate the invention without, however, limiting its scope.

### EMBODIMENT EXAMPLES OF THE INVENTION

### Procedures Used in the Application Tests

### a) Types of Pulps Used

### Pulp of Recycled Fibers:

The wet pulp is obtained by disintegration of dry pulp in order to obtain a final aqueous concentration of 1% by weight. This is a pulp with a neutral pH consisting of 100% of fibers of recycled cardboard.

### b) Evaluation of the Drainage Performances (DDA)

The DDA (“Dynamic Drainage Analyzer”) enables one to determine automatically the time (in seconds) necessary to vacuum drain a fibrous suspension deposited on a fabric. The polymers are added to the wet pulp (0.6 liter of pulp at 1.0% by weight) in the cylinder of the DDA under stirring at 1000 rpm:
T=0 s: stirring of the pulp
T=20 s: addition of the polymer
T=30 s: stopping of the stirring and vacuum drainage at 200 mbar (1 bar=10⁵ Pa) for 70 seconds.

The pressure under the fabric is recorded as a function of time. When all the water has been removed from the fibrous mat, the air passes through said mat causing a break in slope of the curve representing the pressure under the fabric as a function of time. The time, expressed in seconds, recorded at this break in slope corresponds to the drainage time. The shorter the time, the better the vacuum drainage thus is.

c) Performances in DSR (Dry Strength) Application, Grammage at 90 g·m⁻²

The necessary quantity of pulp is collected so as to obtain a sheet having a grammage of 90 g·m⁻².

The wet pulp is introduced into the vat of the dynamic sheet former and maintained under stirring. The different components of the system are injected into this pulp according to the predefined sequence. In general, a contact time of 30 to 45 seconds is complied with between each addition of polymer. Paper sheet formers are implemented with an automatic dynamic sheet former: a blotting paper and the forming fabric are placed in the drum of the dynamic sheet former before starting the rotation of the drum at 1000 rpm and forming the wall of water. The treated pulp is distributed over the wall of water in order to form the fibrous mat on the forming fabric.

Once the water is drained, the fibrous mat is recovered, pressed under a press delivering 4 bars, and then dried at 117° C. The sheet obtained is conditioned for one night in a room with controlled humidity and temperature (50% relative humidity and 23° C.). The dry strength properties of all the sheets obtained by this procedure are then measured.

The bursting (Burst Index) is measured with a Messmer Buchel M 405 bursting tester according to the standard TAPPI T403 om-02. The result is expressed in kPa or as a percentage with respect to a reference. The burst index, expressed in kPa·m²/g, is determined by dividing this value by the grammage of the tested sheet.

The dry breaking length is measured in the machine direction (DBL SM) and in the traverse direction (DBL ST) using a Testometric AX traction apparatus according to the standard TAPPI T494 om-01. The result is expressed in km or as a percentage with respect to a reference.

### Products Tested in the Application Tests

### Polymers P1

Polymer P1-A synthesis

310 g of water are introduced into a 1-liter reactor equipped with a mechanical stirrer, a thermometer, a condenser, and a gaseous nitrogen immersion rod. The pH of the reaction medium is adjusted to 3.3 using a pH buffer (NaOH 30% by weight in water and H₃PO₄ 75% by weight in water). The medium is heated and maintained at a temperature between 79 and 81° C. using a water bath. Using two continuous fluid flows, 400 g of acrylamide at 50%, 237.8 g of water and 2.40 g of sodium hypophosphite at 100% (flow 1) are incorporated for 180 minutes. Fluid flow 2, 0.48 g of sodium persulfate at 100% and 48 g of water for 180 minutes. The polymer solution is maintained at 80° C. for 120 minutes after the end of the fluid flow.

The solution of polymer P1-A obtained has a pH of 5.7, a concentration by weight of polymer P1-A of 20%, and a viscosity of 6000 cps.

Polymer P1-B: Homopolymer of acrylamide in the form of microbeads, marketed by SNF under the name: Flobeads™ AB 300 H.

Polymer P1-C: Homopolymer of acrylamide in the form of a powder, marketed by SNF under the name: Flopam™ FA 920 BPM.

The polymers P1-A (in aqueous solution), P1-B (microbeads) and P1-C (powder) are homopolymers of acrylamide which differ only by their physical form.

### Polymers P2

### Synthesis of Polymer P2-A

Preparation of a solution of P1-A at 10% by weight in water, by diluting 20 g of a solution of P1-A at 20% by weight in water with 20 g of water. The solution of polymer is heated to 50° C.

An aqueous solution of 14.29 g of sodium hypochlorite (NaOCl) at 14.6% (by weight in water) and 7.5 g of soda at 30% (by weight in water) is prepared as a function of the coefficients alpha (0.5) and beta (2.0) for the reaction Re. When the solution of polymer P1-A is at 50° C., the aqueous solution of sodium hypochlorite and soda is added on P1-A. After 30 seconds of reaction, 138.20 g of water are added. The polymer P2-A at a concentration of 2% by weight is obtained.

### Synthesis of Polymers P2-B and P2-C

An aqueous solution M1 of 3.11 g of sodium hypochlorite (NaOCl) at 14.6% (by weight in water) and 1.63 g of soda at 30% (by weight in water) is prepared as a function of the coefficients alpha (0.5) and beta (2.0) for the reaction Re. 37.7 g of water are then added.

0.87 g of polymer P1-B or P1-C are added to the aqueous solution M1 at ambient temperature and under stirring. The polymer in the form of a suspension dissolves and reacts for 120 minutes in the aqueous solution of sodium hypochlorite and soda. The solutions of polymers P2-B or P2-C are respectively obtained with a final concentration by weight of polymer equal to 2%.

### Application Tests

### Drainage Performances (DDA)

TABLE 1
Drainage as a function of the polymer.

Drainage (s)

| | 1.7 kg/T | 3.4 kg/T |
|---|---|---|
| P2-A | 21.04 | 15.65 |
| P2-B | 12.12 | 9.53 |
| P2-C | 11.47 | 9.17 |

| | |
|---|---|
| Blank | 34.39 |

An improvement of the drainage is observed with the use of the polymers P2-B and P2-C (with respect to the polymer P2-A).

### Performances in DSR (Dry Strength) Application

TABLE 2
Dry strength as a function of the polymer.

| | % Burst | % DBL | % DBL |
|---|---|---|---|
| | index | SM | ST |
| Blank | ref. | ref. | ref. |
| P2-A | 17% | 14% | 27% |
| P2-B | 34% | 23% | 34% |
| P2-C | 25% | 16% | 49% |

The Burst performances are improved by the use of the polymers P2-B and P2-C. The same trend is observed for the measurement of the breaking length in the machine direction (DBL SM) and in the traverse direction (DBL ST).

1. A method for producing a sheet of paper or cardboard from a fibrous suspension, comprising:
a) injecting a polymer P2 into a fibrous suspension,
b) forming of a sheet of paper or cardboard,
c) drying of the sheet of paper or cardboard,
wherein the polymer P2 is prepared, before said a), from a water-soluble polymer P1 in the form of solid particles, said P1 is a water-soluble polymer of at least one nonionic monomer selected from the group consisting of acrylamide, methacrylamide, N,N-dimethylacrylamide, and acrylonitrile,
wherein the polymer P2 is obtained by a reaction Re comprising addition and dissolution of the solid particles of water-soluble polymer P1 in an aqueous solution M1 comprising:
(i) an alkali metal hydroxide, or an alkaline earth metal hydroxide or mixtures thereof, (ii) an alkali metal hypohalide, or an alkaline earth metal hypohalide or mixtures thereof,
wherein the reaction Re has a reaction time of 10 seconds to 5 hours after the addition of the particles of water-soluble polymer P1.

2. The method according to claim 1, wherein the water-soluble polymer P1 contains at least 50 mol % of at least one nonionic monomer selected from the group consisting of acrylamide, methacrylamide, N,N-dimethylacrylamide, and acrylonitrile.

3. The method according to claim 1, wherein the water-soluble polymer P1 is a homopolymer or a copolymer of acrylamide or of methacrylamide.

4. The method according to claim 1, wherein, for the reaction Re, the coefficient Alpha=moles of hypohalide/moles of nonionic monomer(s) of the water-soluble polymer P1 is between 0.1 and 1.0, and the coefficient Beta=moles of hydroxide/moles of hypohalide is between 0.5 and 4.0.

5. The method according to claim 1, wherein the solid particles of water-soluble polymer P1 are in the form of powder, microbeads, solid particles in an oily suspension, or solid particles in an aqueous suspension.

6. The method according to claim 1, wherein the solid particles of water-soluble polymer P1 are in the form of a powder resulting from a gel polymerization or of microbeads resulting from inverse suspension polymerization.

7. The method according to claim 6, wherein when the solid particles of water-soluble polymer P1 are in the form of powder which is dispersed in the aqueous solution M1 by a device for dispersing and grinding polymer, supplied by a circuit of the aqueous solution M1.

8. The method according to claim 1, wherein between 0.1 and 20% by weight of solid particles of water-soluble polymer P1 are added to the aqueous solution M1.

9. The method according to claim 1, wherein, at the end of the reaction Re, and before the injection into the fibrous suspension, the polymer P2 is functionalized with a compound comprising at least one aldehyde function to yield a polymer P3.

10. The method according to claim 9, wherein the compound comprising at least one aldehyde function is glyoxal.

11. The method according to claim 1, wherein, before the injection into the aqueous suspension, the pH of the reaction mixture obtained by the reaction Re and containing the polymer P2 is adjusted by addition of acid between 0.5 and 7.5.

12. The method according to claim 1, wherein the polymer P2 or P3 is introduced into the white water and/or into the thick pulp and/or into the mixture formed by the white water and the thick pulp after homogenization of the fibrous suspension in the dilution pump.

13. The method according to claim 1, wherein said a) is carried out within a time period not exceeding 24 hours counting from the addition of the solid particles of water-soluble polymer P1 to the aqueous solution M1.

14. The method according to claim 1, wherein the reaction Re is carried out at a temperature between 10 and 30° C.

15. The method according to claim 1, wherein between 0.3 and 10% by weight of solid particles of polymer P1, with respect to the weight of the aqueous solution M1, are added to the aqueous solution M1.

16. The method according to claim 1, wherein the reaction Re is carried out at a temperature between 15 and 25° C.
